(19) United States
(12) Patent Application Publication
(10) Pub. No.: US 2011/0174793 A1
(43) Pub. Date: Jul. 21, 2011

(54) ROBOT SYSTEM HAVING POSITIONER

(75) Inventors: Keisuke Shiraga, Fukuoka (JP); Masaaki Hara, Fukuoka (JP); Mitsuyoshi Nakano, Fukuoka (JP)

(73) Assignee: KABUSHIKI KAISHA YASKAWA DENKI, Kitakyushu-shi (JP)

(21) Appl. No.: 12/973,926

(22) Filed: Dec. 21, 2010

(30) Foreign Application Priority Data
Jan. 19, 2010 (JP) 2010-008795

(51) Int. Cl. B23K 9/00

(52) U.S. Cl. 219/136

(57) ABSTRACT

A robot system includes a work object, a robot that carries out work on the work object, and a positioner that positions the work object, and the robot is mounted on a mount of the positioner.

### CROSS-REFERENCE TO RELATED APPLICATION

The present application claims priority under 35 U.S.C. §119 to Japanese Patent Application No. 2010-008795 filed Jan. 19, 2010. The contents of the application are incorporated herein by reference in their entirety.

### BACKGROUND OF THE INVENTION

1. Field of the Invention

The present invention relates to a robot system having a positioner.

2. Description of the Related Art

Typical examples of manufacturing lines having a manufacturing process include a welding line for automotive parts or the like. A known welding line system using a robot and a positioner that positions parts is proposed in Japanese Unexamined Patent Application Publication No. 1990-202606.

### SUMMARY OF THE INVENTION

According to one aspect of the present invention, a robot system includes a work object, a positioner that positions the work object, and a robot that carries out work on the work object, wherein the robot is disposed on the top of the positioner.

According to another aspect of the present invention, a positioner that positions an object includes a mount and a rib structure inside the mount, wherein a robot is placed on the top of the mount.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view showing waiting attitudes of welding robots of a robot system;

FIG. 2 is a perspective view showing welding attitudes of the welding robots of the robot system;

FIGS. 3A and 3B are a front view and a side view of a positioner of an embodiment of the present invention; and

FIGS. 4A and 4B are a front view and a side view of a positioner without ribs.

### DESCRIPTION OF THE PREFERRED EMBODIMENTS

Embodiments will now be described with reference to the accompanying drawings, wherein like reference numerals designate corresponding or identical elements throughout the various drawings.

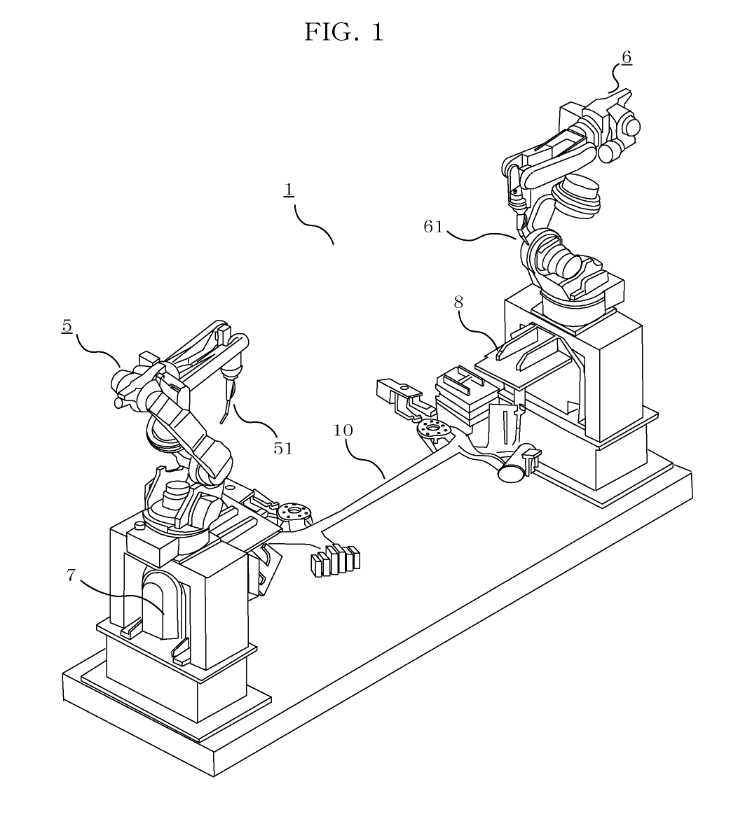

In this embodiment, as shown in FIG. 1, a work object 10 that is an elongate object, such as an automobile chassis, is attached to a first positioner 7 and a second positioner 8 of a first welding process 1 by a transfer robot (not shown). Next, the first positioner 7 and the second positioner 8 rotate according to the location to be welded, and the first welding robot 5 and the second welding robot 6 weld a predetermined location. After the welding, the work object 10 is disposed on a workbench (not shown) by the transfer robot.

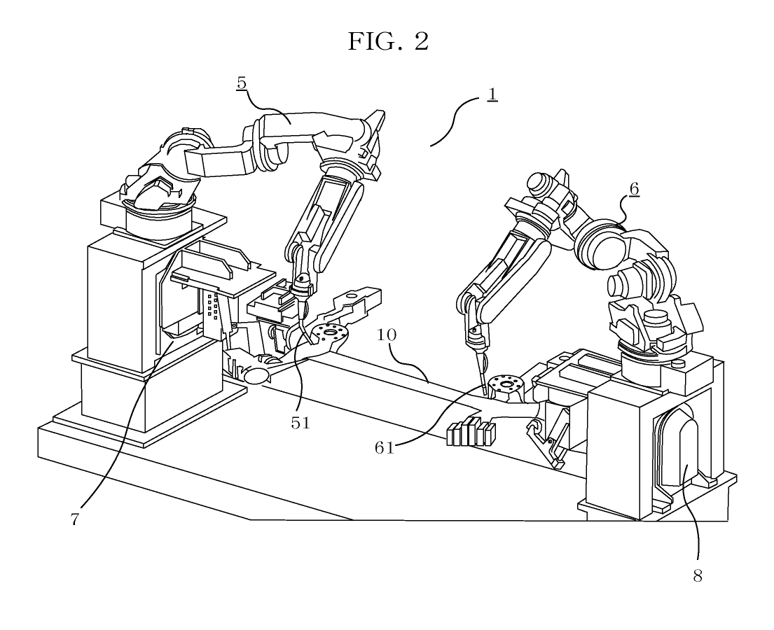

Next, a detailed description will be given by taking the first welding process as an example with reference to FIGS. 1 and 2. FIG. 1 is a perspective view when the welding robots are located in waiting positions. FIG. 2 is a perspective view when the welding robots are performing welding. As shown in FIG. 1, in the first welding process 1, the first welding robot 5 and the second welding robot 6 are disposed on the tops of the first positioner 7 and the second positioner 8, respectively. The first welding robot 5 and the second welding robot 6 are provided with welding torches 51 and 61 at the tips thereof, and are configured to weld a predetermined location of the work object 10.

The first positioner 7 and the second positioner 8 rotate about the longitudinal axis of the work object 10. FIG. 2 shows welding work. In FIG. 2, predetermined locations of the work object 10 are welded. The first welding robot 5 and the second welding robot 6 are configured to approach the work object 10 from above and to be able to weld even locations near the bases of the first welding robot 5 and the second welding robot 6. The first welding robot 5 and the second welding robot 6 operate in cooperation with the first positioner 7 and the second positioner 8. When welding the underside of the work object 10, the first positioner 7 and the second positioner 8 rotate in cooperation with each other until the locations to be welded face the first welding robot 5 and the second welding robot 6 so that welding work can be performed. Although a work object is rotated by two positioners in cooperation with each other here, a work object may be rotated by a positioner and a rotatable mechanism as long as the positioner can bear the load weight of the work object.

Using positioners also as bases for welding robots eliminates the need for space to install the welding robots. By disposing welding robots on the tops of positioners and linearly arranging the two welding robots and the two positioners, the footprint can be reduced.

Because welding robots are disposed on the tops of positioners, moment loads act on the positioners due to the operation of the welding robots and may rock the mounts of the positioners. For this reason, when designing the mounts of the positioners, countermeasures against moment loads are taken into account. The details will be described below.

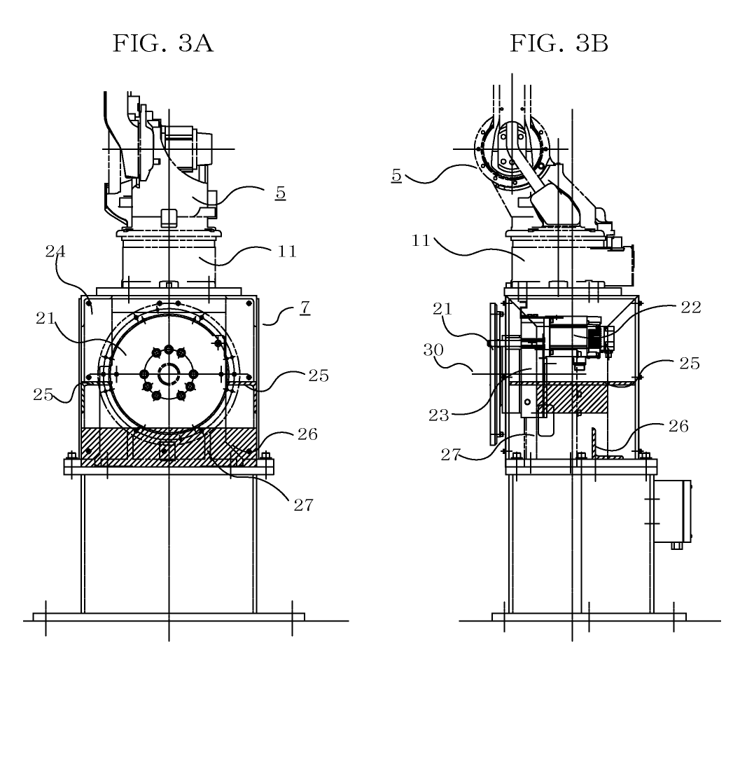

The details of the first positioner will be described with reference to FIGS. 3A and 3B. The second positioner has the same shape as the first positioner, so the description thereof will be omitted. The positioner 7 is a single-axis rotation positioner. FIG. 3A is a front view, and FIG. 3B is a side view. The positioner 7 has such a structure that a rotation positioner can be installed in a mount 24. The rotation axis 30 is parallel to the ground. A driving motor 22 for rotation is attached. The output shaft of the driving motor 22 is connected through a gear and a shaft (both not shown) to the input shaft of a reducer 23 having a hole through which a cable can be passed. The reducer 23 is fixed to a swivel 21 and is rotatably supported. The swivel 21 and the reducer 23 are disposed on the rotation axis 30. The driving motor 22 and the reducer 23 are fixed to a support 27.

Next, the configuration of the mount 24 will be described. The mount 24 has a hollow box shape. A first rib 26 having an L shape is laid on the inner surface of the bottom plate of the mount 24. The first rib 26 extends between the side plates in the transverse direction as viewed from the front (FIG. 3A). The first rib 26 is located near the middle of the mount 24 in the front-back direction and so as not to interfere with the support 27. The first rib 26 is fixed to the side plates and the bottom plate, for example, by welding.

In addition, second ribs 25 having an L shape are laid on the inner surfaces of the side plates of the mount 24. The second ribs 25 extend between the front and back plates as viewed from the side (FIG. 3B). The second ribs 25 are located so as not to interfere with the reducer 23. The second ribs 25 are fixed to the side plates and the front and back plates, for example, by welding.

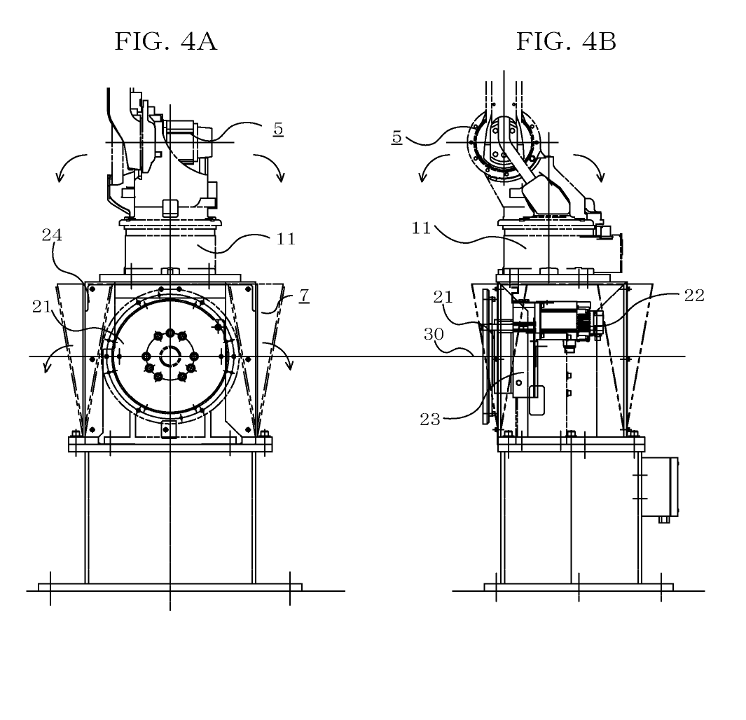

If the first rib 26 and the second ribs 25 are not laid in the mount 24 and when the welding robot 5 changes the attitude from side to side as viewed from the front, the moment load of the welding robot 5 acting on the mount 24 rocks the entire mount 24 from side to side as shown in FIG. 4A. This results in rocking of the rotation axis 30 and reduces the accuracy of welding. In addition, an excessive force acts on the driving motor 22 and the reducer 23 mounted on the inside and contributes to the reduction in their life-spans. Similarly, as shown in FIG. 4B, when the welding robot 5 changes the attitude to and fro, the entire mount 24 is also rocked by the moment load of the welding robot 5.

As a countermeasure against these moment loads, the stiffness is increased so that rocking can be prevented, by laying the first rib 26 and the second rib 25 near the middle of the mount 24 as shown in FIGS. 3A and 3B.

The welding robot 5 is not always disposed on the top of the positioner 7. Depending on the application, the welding robot 5 may be disposed on the ground. Therefore, the first rib 26 and the second rib 25 are laid in the positioner 7, for example, by welding after the driving motor 22 and the reducer 23 are provided. This makes it possible to make a modification according to the status of use of the welding robot 5.

What is claimed as new and is desired to be secured by Letters Patent of the United States is:

1. A robot system comprising:
a work object;
a positioner that positions the work object; and
a robot that carries out work on the work object,
wherein the robot is disposed on the top of the positioner.

2. The robot system according to claim 1, wherein the positioner includes a mount having a rib structure that prevents rocking due to a moment load caused by the operation of the robot.

3. The robot system according to claim 2, wherein the rib structure includes at least one of first and second ribs, the first rib is provided so as to prevent rocking due to a movement of the robot from side to side, and the second rib is provided so as to prevent rocking due to a to-and-fro movement of the robot.

4. A positioner that positions an object, the positioner comprising:
a mount; and
a rib structure inside the mount,
wherein a robot is placed on the top of the mount.

5. The positioner according to claim 4, wherein the rib structure is laid after a driving motor that drives the positioner is provided.
